(19) United States
(12) Patent Application Publication
(10) Pub. No.: US 2024/0294275 A1
(43) Pub. Date: Sep. 5, 2024

(54) CONTROL METHOD, APPARATUS AND SYSTEM FOR MOVABLE PLATFORM, AND CONTROL TERMINAL

(71) Applicant: SZ DJI TECHNOLOGY CO., LTD., Shenzhen (CN)

(72) Inventors: Jian GUAN, Shenzhen (CN); Yanzhen FENG, Shenzhen (CN); Yanglin HUANG, Shenzhen (CN); Xianhua ZHONG, Shenzhen (CN); Shiquan YU, Shenzhen (CN); Zhenchu LI, Shenzhen (CN)

(73) Assignee: SZ DJI TECHNOLOGY CO., LTD., Shenzhen (CN)

(21) Appl. No.: 18/661,047

(22) Filed: May 10, 2024

Related U.S. Application Data
(63) Continuation of application No. PCT/CN2021/130383, filed on Nov. 12, 2021.

(51) Int. Cl. B64U 10/13

(52) U.S. Cl. CPC B64U 10/13; B64U 2201/20

(57) ABSTRACT

A method of controlling a movable platform may comprise determining a current scene role currently used by a control terminal to control a first movable platform as a first scene role, the first scene role characterizing a first service form currently executed by the first movable platform; automatically selecting a corresponding control function based on the current scene role; after determining that the control terminal has disconnected communication connection with the first movable platform and established a new communication connection with a second movable platform, obtaining a second service form to which the second movable platform belongs; and switching the current scene role currently used by the control terminal from the first scene role corresponding to the first service form to which the first movable platform belongs to a second scene role corresponding to the second service form to which the second movable platform belongs.

### CROSS-REFERENCE TO RELATED APPLICATION

The present application is a continuation of International Application No. PCT/CN2021/130383, filed Nov. 12, 2021, the entire content of which being incorporated herein by reference in its entirely.

### TECHNICAL FIELD

The present application relates to the field of computer technology and, in particular, to a method, apparatus, system, control terminal for controlling a movable platform.

### BACKGROUND

With the wide application of movable platform such as unmanned devices, unmanned devices can be used in various service forms to replace human work, thus improving the productivity of that service forms.

In the related technology, for each service form, a corresponding control terminal is required to control the movable platform such as the unmanned device under the service form, and the corresponding firmware is burned into the control terminal. Since the functional requirement corresponding to different service form differ greatly, the firmware used is different, resulting in inefficient control and management of unmanned device under different service form.

### SUMMARY

According to an aspect of embodiments of the present disclosure, a method of controlling a movable platform, comprising:
determining a current scene role currently used by a control terminal to control a first movable platform as a first scene role, the first scene role characterizing a first service form currently executed by the first movable platform;
automatically selecting a corresponding control function based on the current scene role;
after determining that the control terminal has disconnected communication connection with the first movable platform and established a new communication connection with a second movable platform, obtaining a second service form to which the second movable platform belongs; and
switching the current scene role currently used by the control terminal from the first scene role corresponding to the first service form to which the first movable platform belongs to a second scene role corresponding to the second service form to which the second movable platform belongs.

According to another aspect of embodiments of the present disclosure, a control apparatus for a moveable platform, comprising:
at least one processor; and
at least one memory including computer program code, where the at least one memory and the computer program code are configured, with the at least one processor, to cause the control apparatus to at least:
determine a current scene role currently used by a control terminal to control a first movable platform as a first scene role, the first scene role characterizing a first service form currently executed by the first movable platform;
automatically select a corresponding control function based on the current scene role;
after determining that the control terminal has disconnected communication connection with the first movable platform and established a new communication connection with a second movable platform, obtain a second service form to which the second movable platform belongs; and
switch the current scene role currently used by the control terminal from the first scene role corresponding to the first service form to which the first movable platform belongs to a second scene role corresponding to the second service form to which the second movable platform belongs.

According to another aspect of embodiments of the present disclosure, a control system for a movable platform, the control system comprising:
a control apparatus;
a first removable platform and a second removable platform;
the control apparatus comprises:
at least one processor; and
at least one memory including computer program code, where the at least one memory and the computer program code are configured, with the at least one processor, to cause the control apparatus to at least:
determine a current scene role currently used by a control terminal to control the first movable platform as a first scene role, the first scene role characterizing a first service form currently executed by the first movable platform;
automatically select a corresponding control function based on the current scene role;
after determining that the control terminal has disconnected communication connection with the first movable platform and established a new communication connection with the second movable platform, obtain a second service form to which the second movable platform belongs; and
switch the current scene role currently used by the control terminal from the first scene role corresponding to the first service form to which the first movable platform belongs to a second scene role corresponding to the second service form to which the second movable platform belongs.

It should be understood that the above general description and the detailed description that follows are exemplary and explanatory only and do not limit the present application.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1 is an architectural diagram of a control system for a movable platform provided by an embodiment of the present application;

FIG. 2 is a flowchart of a method of controlling a movable platform provided by an embodiment of the present application;

FIG. 3 is a flowchart of a method of controlling a movable platform provided by an embodiment of the present application;

FIG. 4 is an interface diagram of a movable platform provided by an embodiment of the present application;

FIG. 5 is an interface diagram of another movable platform provided by an embodiment of the present application;

FIG. 6 is an interface diagram of another movable platform provided by an embodiment of the present application;

FIG. 7 is an interface diagram of another movable platform provided by an embodiment of the present application;

FIG. 8 is a schematic diagram of a firmware upgrade for a removable platform provided by an embodiment of the present application;

FIG. 9 is a flowchart of another method of controlling a movable platform provided by an embodiment of the present application;

FIG. 10 is a block diagram of a control apparatus for a movable platform provided by an embodiment of the present application.

### DETAILED DESCRIPTION

In order to make the objects, technical solutions and advantages of the present disclosure more apparent, example embodiments according to the present disclosure will be described in detail below with reference to the accompanying drawings. Obviously, the described embodiments are only a part of the embodiments of the present disclosure and not all of the embodiments of the present disclosure, and it should be understood that the present disclosure is not limited by the example embodiments described herein. Based on the embodiments of the present disclosure described herein, all other embodiments obtained by a person skilled in the art without creative labor should fall within the scope of protection of the present disclosure.

In the following description, a large number of specific details are given in order to provide a more thorough understanding of the present disclosure. However, it will be apparent to those skilled in the art that the disclosure can be practiced without one or more of these details. In other examples, some technical features well known in the art are not described in order to avoid confusion with the present disclosure. It should be understood that the present disclosure is capable of being practiced in different forms and should not be construed as being limited to the embodiments presented herein.

The terms used herein are intended to describe specific embodiments only and are not intended to be a limitation of the present disclosure. As used herein, the singular forms “one”, “a”, and “that” are also intended to include the plural form unless the context clearly indicates otherwise. It should also be understood that the terms “comprising” and/or “including”, when used in this specification, identify the presence of features, integers, steps, operations, elements and/or components, but do not exclude the presence or grouping of one or more other features, integers, steps, operations, elements, or components. As used herein, the term “and/or” includes any and all combinations of the relevant listed items.

For a thorough understanding of the present disclosure, a detailed structure will be presented in the following description in order to elucidate the technical solutions proposed by the present disclosure. Optional embodiments of the present disclosure are described in detail below, however, in addition to these detailed descriptions, the disclosure may have other embodiments.

The image annotation method and the apparatus and system of the present application are described in detail below in conjunction with the accompanying drawings. The features in the following embodiments and implementations may be combined with each other without conflict.

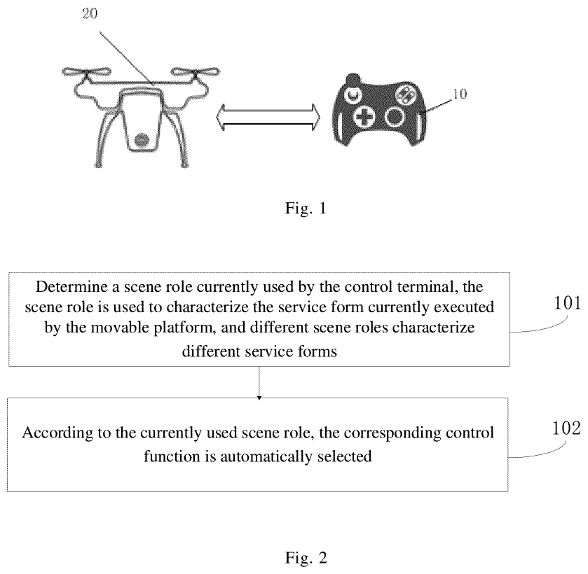

Referring to FIG. 1, an architectural diagram of a control system according to one embodiment of the present disclosure for a movable platform is shown, the control system for the movable platform comprising: a control terminal and a movable platform. The control terminal may realize communication and control with the movable platform, and the realization of such communication and control may be realized based on firmware installed in the control terminal, which may be a remote control device, a server, a personal computer, a mobile terminal, and the like. The forms of realization of the movable platform include but are not limited to: aircraft, vehicles, ships, intelligent robots, etc. The movable platform can be manned or unmanned. Optionally, the aircraft includes unmanned aerial vehicles. The aircraft may include but are not limited to any one of manned aircraft, logistics aircraft, aerial photography aircraft, agricultural plant protection aircraft, industrial rescue aircraft, and performance aircraft. The above are only examples. The embodiments of this application do not specifically limit the type of aircraft.

Specifically, a service form can be understood as a service scene currently executed by the movable platform, and under a service form, a movable platform matching the service form can be adopted to realize corresponding service functions. Optionally, the service form may include: an industry level service form, an agricultural level service form, a performance level service form, a consumer level service form, or a service form applied to other fields, and the like.

For example, for the movable platform under the agriculture level service form and the movable platform under the performance level service form, the agriculture level service form can be used to realize watering and spraying pesticides by the movable platform in the farmland, etc., while the performance level service form can be used to allow the movable platform to fly in accordance with the performance action and realize the performance. The control and communication forms and functions realized by the mobile platforms under these two different service forms are quite different, which makes these two different service forms separated from each other, i.e. it is not possible to control the mobile platform under the performance level service form to perform operations according to the control and communication methods of the mobile platforms under the agriculture level service form, and vice versa.

In the application process, although there are large differences in the control and communication methods of different service forms of mobile platforms, the control terminals of different service forms of mobile platforms have the same or similar hardware. In order to realize the rapid switching of multiple different service forms based on the control of a single control terminal, the embodiments of the present application can set up a number of scene roles in the control terminal, and each scene role is used to characterize the service form of a mobile platform, and the service forms characterized by different scene roles are different. Each scene role is used to characterize the service form of a movable platform, and different scene roles characterize different service forms; after the control terminal is activated, the scene role currently used by the control terminal can be determined according to the requirements of the actual service form, and the movable platform under the service form can be controlled to perform operations in accordance with manipulation and communication modes of the service form; when the requirements are changed, the scene role can be rapidly switched to another scene role by switching the scene roles on the control terminal. When the demand changes, it can quickly switch to another service form by switching the scene role on the control terminal, and control the movable platform under the switched service form to perform operations in accordance with the control and communication method under the switched service form.

It should be noted that a movable platform can also have multiple different service forms, and the movable platform can switch the currently executed service form according to the actual demand. After the movable platform switches the service form, the control terminal can correspondingly switch the currently used scene role to the scene role corresponding to the switched service form, so as to achieve the purpose of correspondingly switching the scene role of the movable platform to match the current service form according to the switching of the movable platform. In this way, the purpose of switching the scene role of the mobile platform to match the service form of the mobile platform can be achieved.

For example, a movable platform can mount load equipment for agricultural use or load equipment for industry use, so that the movable platform can have an agricultural level service form and an industry level service form. Assuming that the movable platform currently mounts load equipment for industry use, and the control terminal is currently using an industry level scene role. Then, when the movable platform is switched to mount load equipment for agricultural use, the scene role currently used by the control terminal can be switched from the industry level scene role to the corresponding agriculture level scene role.

In some embodiments of the present application, the management of movable platforms under different service forms can be realized by adopting role management on the same control terminal. Since the scene roles are bound one by one with the service forms, and the control terminal can only use one scene role to control the movable platform at one time, mutual interference in the control of movable platforms under different service forms can be avoided, so the embodiments of the present application realize the management of movable platforms under different service forms by using the same control terminal through the concept of scene roles. As such, the management of the movable platform under different service forms is realized by using the same control terminal, e.g., when it is necessary to switch service forms, it can be realized by switching scene roles on one control terminal, which improves the control and management efficiency of the movable platform under different service forms.

FIG. 2 is a flowchart of a method of controlling a movable platform provided by an embodiment of the present application, applied to a control terminal, as shown in FIG. 2, which may include:

Step 101: determine a scene role currently used by the control terminal, the scene role is used to characterize the service form currently executed by the movable platform, and different scene roles characterize different service forms.

In one embodiment of the present application, the establishment of scene roles can be realized in the firmware of the control terminal by writing a scene role list. Specifically, the scene roles that need to be realized can be added to the scene role list, and then the scene role list is written into a persistent area (a slice that cannot be directly tampered with) in the storage space of the control terminal, which can be accessed by the firmware, thus realizing that the control terminal can read the scene roles, and the change of the scene roles in the scene role list needs to be realized by means of firmware upgrading. The scene roles can be read by the control terminal. In addition, the change of scene roles in the scene role list needs to be realized by upgrading the firmware, which improves the stability and security of the scene role establishment process.

For example, a control terminal can set these three scene roles in the control terminal by means of a scene role list in order to realize fast switching between an agriculture level scene role, an industry level scene role and a performance level scene role, and the control terminal can read a scene role for application at one time.

In this step, after the control terminal is started, the scene role currently in use may be determined, and the scene role currently in use include, but are not limited to, the scene role selected by the user, the scene role after switching roles, and the scene role used by the control terminal before it was last shut down.

Step 102: According to the currently used scene role, the corresponding control function is automatically selected.

In an embodiment of the present application, after determining the currently used scene role, a control function corresponding to the scene role can be automatically selected, and in one realization, the control function comprises: the control terminal applies the manipulation and communication method under the service form corresponding to the currently used scene role, so as to control the movable platform under the service form to perform operations, such as controlling the movable platform to take off and perform flight tasks, etc.

For example, when the user selects an agricultural level scene role on the control terminal, the control application for the movable platform under the agricultural level service form can be started, and the control application for the movable platform under the agricultural level service form provides the control interface required for controlling the movable platform under the agricultural level service form, and provides parameters for controlling the control and communication mode of the movable platform under the agricultural level service form and configures them in the control terminal. The entire configuration process may be automated or completed based on a user's instruction, so as to enable the user to realize the control operation of the movable platform through the control application for the movable platform in the form of the agricultural level service.

In another realization method, the automatically selected control function corresponding to the scene role may not be for controlling the movable platform to perform the operation, but the corresponding control function is performed on the control terminal, such as running the control application of the movable platform to configure the relevant parameters, and performing the establishment of the work task (e.g., dividing the task area in the map interface of the control application), and in these cases, the removable platform does not perform the control operation.

In summary, one embodiment of the present application provides a method of controlling a movable platform, which can realize the management of movable platforms in different service forms by adopting role management on the same control terminal. Since the scene roles are bound one by one to the service forms, and the control terminal can only use one scene role to control the movable platform at one time, the control of the movable platforms in multiple service forms can be avoided. Therefore, the embodiment of the present application realizes the management of the movable platform under different service forms by using the same control terminal through the concept of scene roles, for example, when it is necessary to switch the service form, it can be realized by switching scene roles on the control terminal, which improves the control and management efficiency of the movable platform under different service forms.

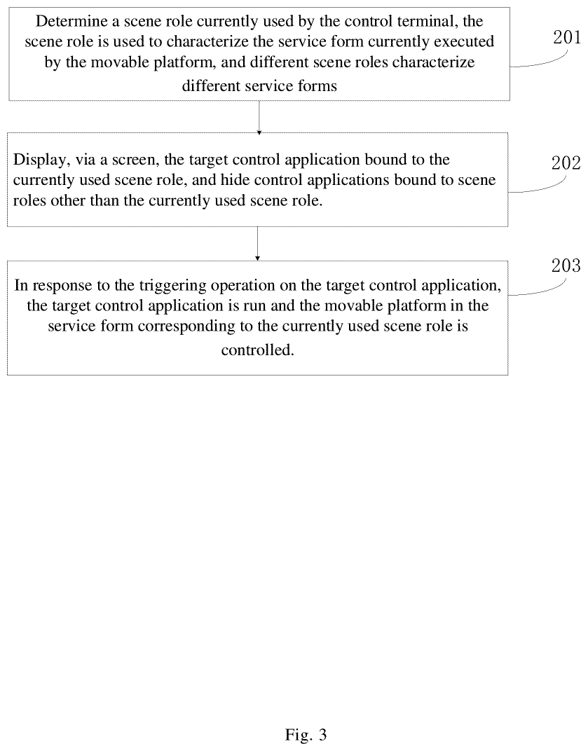

FIG. 3 is a specific flowchart of a method of controlling a movable platform provided by an embodiment of the present application, which may include, as shown in FIG. 3:

Step 201: Determine a scene role currently used by the control terminal, the scene role is used to characterize a service form currently executed by the movable platform, and different scene roles characterize different service forms.

This step can be specified with reference to 101 above and will not be repeated here.

Optionally, the service forms may include: an industry level service form, an agricultural level service form, a performance level service form, a consumer level service form in or applied to other fields, and so forth.

Optionally, in one implementation, step 201 may specifically include, in order to achieve the determination of the currently used scene role:
Substep 2011: Determine the scene role that is set by default at the startup of the control terminal as the currently used scene role.

In one realization of the embodiments of the present application, a scene role can be selected as the scene role set by default at the startup of the control terminal during a setting operation of the control terminal, and after the setting operation is completed, the control terminal will directly determine the scene role to be the scene role currently in use every time it is started up, so as to achieve the purpose of quickly setting the scene role currently in use. It should be noted that when the control terminal is booted up for the first time, the scene role currently used can also be the scene role set by the system by default, i.e., it is possible to determine the scene role used when the control terminal is booted up for the first time without the user setting operation.

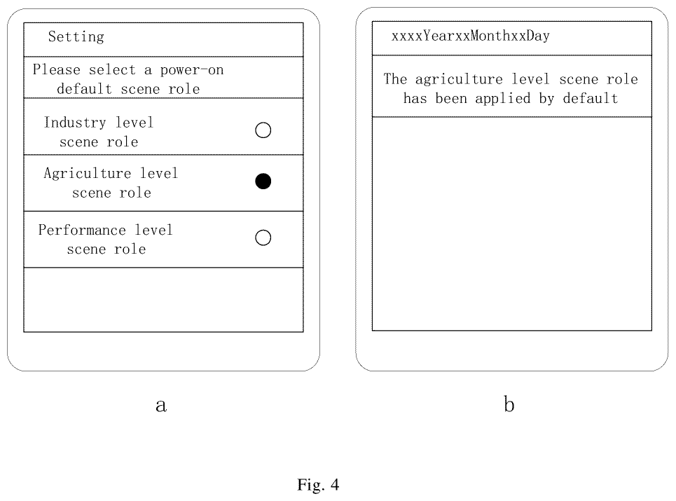

For example, referring to FIG. 4, which illustrates a control interface diagram of a movable platform provided by an embodiment of the present application, the control terminal may be provided with P1 setting interface a. Assuming that, after a user has selected an agricultural level scene role in the power-on default role setting interface a, the agricultural level scene role will be taken as the currently utilized role in each subsequent power-on of the control terminal, and prompted to prompt in the power-on interface b that “The agricultural level scene role has been applied by default.”.

Optionally, in another implementation, step 201 may specifically include, in order to achieve the determination of the currently used scene role:
Substep 2012: the user is prompted to make a selection of a scene role by the information output device, and in response to the role selection operation of the user, the selected scene role is determined to be the currently used scene role.

In this step, the information output device can be an indicator light, screen, speaker, etc. of the control terminal, and prompting the user to select the scene role through the information output device can include: for example, when the information output device is the indicator light, it can remind the user to select the scene role in a lighted way, specifically, for example, when the indicator light on the control terminal is lit 3 times on behalf of the scene role, the user can select the corresponding scene role by pressing a key, such as key 1 for selecting scene role 1; key 2 for selecting scene role 2; when the information output device is the screen, it can display the role selection interface. When the information output device is a screen, it can remind the user to select the scene role by displaying the role selection interface, and the user can select the currently used scene role in the selection interface displayed on the screen; when the information output device is a speaker, it can remind the user to select the scene role by playing the voice. When the information output device is a loudspeaker, the user is reminded of the selection of the scene role by means of a voice, for example, the loudspeaker of the control terminal announces the voice of “please select the scene role”, so that the user carries out the operation of selecting the scene role. In addition, the user's specific operation of selecting the scene role includes but is not limited to selecting the scene role by touching the screen in the interface of the screen, selecting the scene role by triggering the corresponding physical button, and selecting the scene role by voice control, and so on.

Optionally, sub-step 2012 may specifically include sub-steps 20121-20122:
Sub-step 20121, a scene role selection interface including a plurality of scene roles is displayed via a screen.
Substep 20122, in response to a selection operation of a scene role in the scene role selection interface, the selected scene role is determined to be the currently used scene role.

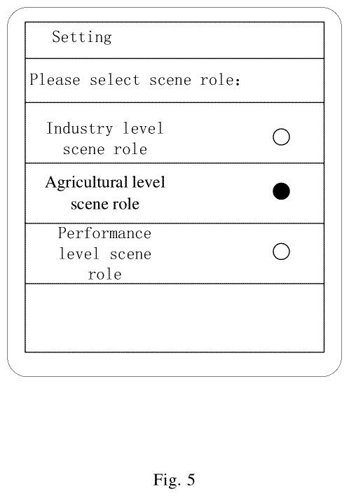

Some embodiments of the present application carry out a description related to sub-steps 20121-2012 by way of an example, with reference to FIG. 5, which illustrates a diagram of a control interface of a movable platform provided by the embodiments of the present application, wherein the control terminal may provide an interface for selecting a scene role, and assuming that the user has selected an agricultural level scene role in the interface for selecting scene roles, the agricultural level scene role may be determined as the currently used scene role.

Optionally, in another implementation, step 201 may specifically include, in order to achieve the determination of the currently used scene role:
Substep 2013: determines the scene role used by the control terminal before the last shutdown as the scene role currently in use.

In one embodiment of the present application, based on user habit, the user usually continues to identify the scene role used in the control of the last movable platform as the scene role used in the subsequent control of the movable platform, and therefore, the embodiment of the present application may continue to identify the scene role used in the control terminal before the control terminal was shut down previously as the scene role used in the control terminal when the control terminal is turned on in the present time, thereby making the selection of the scene role more in line with the user's habit and improves the user experience.

Optionally, in another implementation, step 201 may specifically include sub-steps 2014-2015 in order to enable the determination of the currently used scene role:
Sub-step 2014, obtaining a target service form to which the movable platform belongs, the movable platform is communicatively connected to the control terminal.
Substep 2015: identify the scene role corresponding to the target service form as the currently used scene role.

In one embodiment of the present application, a service form may have one or more supported models of the removable platform, e.g., an agricultural level service form may support three models of the removable platform, A, B, and C, which allows the removable platform to have a target service form to which it belongs.

Specifically, the control terminal can obtain the target service form belonging to the movable platform with which the communication connection is established, and determine the scene role corresponding to the target service form as the scene role currently in use, so that in a specific application scene, after the control terminal is connected to the movable platform, for example, after the control terminal and the movable platform have completed the frequency pairing, it is possible to automatically determine the service form of the movable platform and switch the control terminal to the scene role corresponding to the service form of the aforementioned movable platform, improving the convenience of control.

Step 202: display, via a screen, the target control application bound to the currently used scene role, and hide control applications bound to scene roles other than the currently used scene role.

Optionally, the scene role has a corresponding binding control application.

In an embodiment of the present application, the scene role can be bound with a control application of the movable platform, and the control application can be an application matching the scene role, for example, used for controlling the movable platform under the service form corresponding to the scene role to perform an operation, or used for carrying out pre-planning in conjunction with the corresponding scene role. The control application may provide a control interface required for the movable platform in the service form, and provide parameters for the control and communication modes of the movable platform, and may configure these parameters in the control terminal, and the entire configuration process is automated, so as to enable the user to realize the control operation of the movable platform by means of the control application for the movable platform in the corresponding service form.

Specifically, the control terminal, after determining the currently used scene role, may display the target control application bound to the currently used scene role in the screen and hide the control applications bound to scene roles other than the currently used scene role for the user to intuitively see the icon of the currently desired target control application.

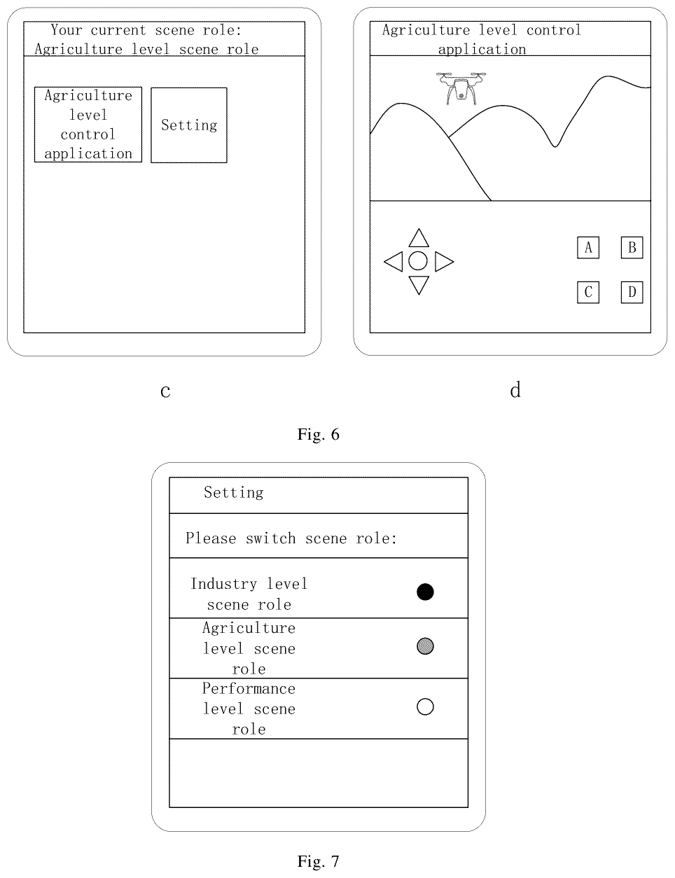

For example, referring to FIG. 6, which illustrates a control interface diagram of a movable platform provided by an embodiment of the present application, when an agriculture level scene role is identified as the currently used scene role, the control terminal may display an icon of an agriculture level control application in the interface c while hiding other applications such as an industry level control application, a performance level control application, and the like.

Step 203: In response to the triggering operation on the target control application, the target control application is run and the movable platform in the service form corresponding to the currently used scene role is controlled.

In this step, referring to FIG. 6, after the control terminal displays an icon of the agriculture level control application in the interface c, if the user performs a triggering operation on the agriculture level control application, the agriculture level control application may be run, providing a control interface d of the agriculture level control application, and the control interface d may contain a preview screen, manipulation buttons, and other elements necessary for the control of the movable platform, and the user may, through the control interface d, control the movable platform in the agricultural level service form to perform operations through the control interface d.

Optionally, in one implementation, the method may further comprise, in order to realize the switching of scene roles:

Step 204: In response to the role switching instruction, the scene role currently used by the control terminal is switched from the first scene role to the second scene role.

In one embodiment of the present application, the control terminal may respond to a role switching instruction initiated by the user to switch the scene role currently used by the control terminal from the first scene role to the second scene role, for example, the user may initiate a role switching instruction by means of interface selection, voice control, key control, etc., so that the scene role currently used by the control terminal is switched from the first scene role to the second scene role, and the control terminal may be switched from the first scene role to the second scene role. The user can initiate the role switching instruction through interface selection, voice control, key control, etc., so that the scene role currently used by the control terminal is switched from the first scene role to the second scene role.

Optionally, step 204 may specifically include:
Sub-step 2041, a role switching interface including a plurality of scene roles is displayed via a screen.
Substep 2042: in response to a switching operation of the scene role in the role switching interface, the scene role currently used by the control terminal is switched from the first scene role to the second scene role.

In an embodiment of the present application, referring to FIG. 7, which illustrates a diagram of a control interface of a movable platform provided by an embodiment of the present application, the control terminal may display a role switching interface including a plurality of scene roles through a screen, and a user may perform a role switching operation in the interface, such as switching an agriculture level scene role to an industry level scene role.

Optionally, in another implementation, the method may further comprise steps 205-206 in order to realize the switching of scene roles:

Step 205: after determining that the control terminal disconnects the communication connection with the first movable platform and establishes a new communication connection with the second movable platform, obtaining the second service form to which the second movable platform belongs.

In another embodiment of the present application, since a service form may have one or more supported models of the removable platform, and the control terminal may acquire the service form to which the removable platform with which it has established a communication connection belongs, when the control terminal determines that it has disconnected the communication connection with the first removable platform and has established a new communication connection with the second removable platform with which the second removable platform belongs, it may acquire the second service form to which the second movable platform belongs.

Step 206: Switch the scene role currently used by the control terminal from a first scene role corresponding to a first service form to which the first movable platform belongs to a second scene role corresponding to a second service form.

In this step, after the control terminal acquires the second service form to which the second movable platform belongs, it can perform a role switching operation to switch the scene role currently used by the control terminal from the first scene role corresponding to the first service form to which the first movable platform belongs to the second scene role corresponding to the second service form, which enables the control terminal to disconnect the old movable platform and connect to the new movable platform. This enables the control terminal to automatically switch the scene role from the old scene role to the new scene role after disconnecting the old removable platform and connecting to the new removable platform, thereby improving the degree of control convenience.

Optionally, in realizing the switching of scene roles, the method may further comprise:

Step 207: In the case where it is determined that there is a communication connection established between the control terminal and the removable platform, switching the scene role currently used by the control terminal is prohibited.

In an embodiment of the present application, in the case where it is determined that the control terminal has established a communication connection with the movable platform, it may be considered that the control terminal is controlling the movable platform in a working state, in which case, in order to avoid interference with the working state of the movable platform brought about by switching the scene role, it may be prohibited to switch the scene role currently being used by the control terminal until the control terminal has disconnected the communication connection with the movable platform. In this case, in order to avoid interference with the working state of the movable platform caused by switching scene roles, the switching of the scene role currently used by the control terminal may be prohibited until the control terminal is disconnected from the movable platform. For example, if the control terminal forcibly switches the current scene role when controlling the movable platform to fly in the air, the movable platform may lose control and crash or other accidents may occur.

Optionally, step 207 may specifically include:
Sub-step 2071: if it is determined that the user is switching the scene role currently used by the control terminal, if the movable platform to which the control terminal is currently connected is in a working state, the user is prompted to prohibit switching the scene role currently used by the control terminal.

In an embodiment of the present application, if the user forcibly performs the operation of switching the scene role when the removable platform currently connected to the control terminal is in a working state, the control terminal may carry out a risk prompt, specifically prompting the user to prohibit the switching of the scene role currently used by the control terminal.

Optionally, in realizing the switching of scene role, the method may further comprise:

Step 208: In switching the scene role currently used by the control terminal from the first scene role to the second scene role, the movable platform control mode of the control terminal is switched from the first mode corresponding to the first scene role to the second mode corresponding to the second scene role.

In one embodiment of the present application, since the control modes of the movable platform under different service forms vary greatly, each service form is correspondingly bound with the control mode of the movable platform under the service form, such as the control mode of the movable platform under the agricultural level service form includes the control mode required for performing operations such as watering and spraying pesticides, etc.; the control mode for the movable platform in the form of performance level service includes the control mode required for performing performance operations.

When the scene role currently used by the control terminal is switched from the first scene role to the second scene role, the control mode of the movable platform of the control terminal can be switched from the first mode corresponding to the first scene role to the second mode corresponding to the second scene role, so as to satisfy the demand for normal and stable control of the movable platform in the service form after the switch.

Optionally, step 208 may specifically include:
Sub-step 2081: switching the function controlled by an operating structure of the control terminal from a first function corresponding to the first scene role to a second function corresponding to the second scene role.

Specifically, the operating structure of the control terminal may include: a button, a dial wheel, a rocker, etc., for controlling the movable platform to perform an operation, and the operating structure may be a virtual operating structure displayed in an interface of a screen or a physical operating structure of a solid body in the control terminal.

In an embodiment of the present application, the functions controlled by the operation structures of the control terminal under different service forms may be different. For example, referring to FIG. 6, there are 4 operation structures in the control interface d of the control application: A,B,C,D. The functions of these 4 operation structures under the industry level service form are: mapping, lighting, voice shouting, and recalling, respectively; and when the scene role is switched from the industry level scene role to the agriculture level scene role, then the functions of these 4 operation structures under the agriculture level service form are: spraying, mode switching, accelerating, and decelerating, respectively.

It should be noted that the functions controlled by the operation structure may be bound to the scene role, specifically may be written in a configuration file bound to the scene role, or the function controlled by the operation structure may be configured via a control application bound to the scene role.

Optionally, the firmware of the control terminal comprises: software radio firmware bound to the scene role; in realizing the switching of the scene role, the method may further comprise:

Step 209: In switching the scene role currently used by the control terminal from the first scene role to the second scene role, the software radio firmware of the control terminal is switched from the first software radio firmware corresponding to the first scene role to the second software radio firmware corresponding to the second scene role.

In an embodiment of the present application, the control terminal may realize the switching of multiple service forms by means of a fixed set of firmware, and the firmware of the control terminal may include: an operating system firmware, a microcontroller unit (MCU, Microcontroller Unit) firmware, and a software radio (SDR, Software Defined Radio) firmware that is bound to a scene role. These firmwares are used to realize the underlying control logic of the control terminal.

In practical application, due to the communication methods between the control terminal and the movable platform under different service forms are quite different (e.g., different communication bands, different communication commands), the firmware of the control terminal can include software radio firmware bound to the scene role, which is used for realizing the function of communicating with the movable platform under the service form of the corresponding scene role. When the scene role is switched from a first scene role to a second scene role, the software radio firmware of the control terminal may be switched from the first software radio firmware corresponding to the first scene role to the second software radio firmware corresponding to the second scene role, so as to satisfy the normal communication function with the new movable platform after the switching of the scene role.

Optionally, to enable the upgrade of the firmware of the movable platform, after step 201, the method may further comprise steps 210-213:

Step 210: obtain firmware online upgrade information matching the currently used scene role.

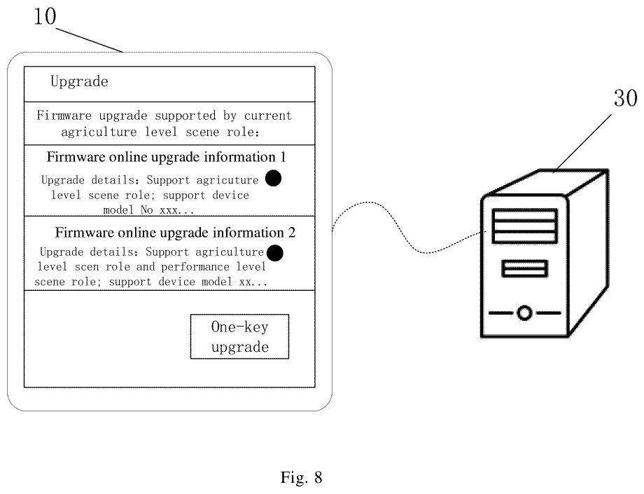

In one embodiment of the present application, a way of online upgrading of a firmware of a control terminal is provided, specifically, with reference to FIG. 8, which illustrates a schematic diagram of online upgrading of a firmware of a movable platform provided by an embodiment of the present application, including a control terminal 10 and a service terminal 30, wherein the service terminal 30 may be a service terminal that communicates directly with the control terminal 10, or it may be the control application of the service terminal 30, such that the control terminal 10 can directly access the service terminal 30 or can access the service terminal 30 through a control application bound by a currently used scene role.

In one embodiment, the firmware online upgrade information has a supported service form, i.e., the scene roles specifically supported by the firmware online upgrade information, i.e., each firmware online upgrade information has a support list, and the support list contains one or more scene roles. For example, the firmware online upgrade information 1 may support the firmware upgrade of an agricultural level scene role; the firmware online upgrade information 2 may support the firmware upgrade of an agricultural level scene role and a performance level scene role, etc.; after determining the scene role currently used by the control terminal, the control terminal of the embodiment of the present application may obtain the firmware online upgrade information that matches the scene role currently used.

Among them, the firmware online upgrade information that matches the currently used scene role can specifically be the firmware online upgrade information of the currently used scene role included in the support list, for example, the firmware online upgrade information 1 can support the firmware upgrade of the agriculture level scene role; the firmware online upgrade information 2 can support the firmware upgrade of the agriculture-level scene role and the performance level scene role, and if the currently used scene role of the control terminal is the agriculture level scene role, then the firmware online upgrade information 1 and the firmware online upgrade information 2 can be obtained for the current online upgrade of the control terminal.

It should be noted that the obtained firmware online upgrade information can be displayed on the screen to inform the user of the current existence of online upgrade push. In addition, the obtained firmware online upgrade information can also be displayed without the screen, for example, after acquiring the firmware online upgrade information, the upgrade information can be broadcasted through the speaker of the control terminal, and the user can be prompted to manipulate the relevant operation pieces to carry out the upgrade; in addition, the upgrade can also be prompted through the indicator light of the control terminal, for example, the continuous high-frequency flashing indicator light represents the current existence of online upgrade push. For example, after obtaining the firmware online upgrade information, it can broadcast the upgrade information through the speaker of the control terminal, and can prompt the user to manipulate the related operation pieces to upgrade, such as pressing the C1 key to upgrade; in addition, after obtaining the firmware online upgrade information, it can also carry out the upgrade prompts through the indicator lights of the control terminal, such as the continuous high frequency blinking indicator represents that there exists an online upgrade push.

Step 211: hide the firmware online upgrade information that does not match the currently used scene role.

In an embodiment of the present application, while obtaining the firmware online upgrade information that matches the currently used scene role, the firmware online upgrade information that does not match the currently used scene role may also be hidden to prevent the user from mistakenly interfering with the current upgrade process by the firmware online upgrade information that does not match the currently used scene role.

Step 212: display the firmware online upgrade information through the screen.

In this step, referring to FIG. 8, assuming that the firmware online upgrade information 1 can support the firmware upgrade of the agricultural level scene role; the firmware online upgrade information 2 can support the firmware upgrade of the agricultural level scene role and the performance level scene role, and the scene role currently used by the control terminal 10 is the agricultural level scene role, the firmware online upgrade information 1 and firmware online upgrade information 2 can be displayed in the screen after obtaining the firmware online upgrade information 1 and firmware online upgrade information 2.

Optionally, the firmware online upgrade information includes the supported scene role and the device model of the supported removable platform.

In addition, when displaying each firmware online upgrade information, the upgrade details of the firmware online upgrade information can also be displayed at the same time, and the upgrade details include the supported scene roles, the device models of the supported removable platforms, and a description of the upgrade contents.

Step 213: In response to an upgrade command to the firmware upgrade online information, the firmware of the control terminal is upgraded online.

In this step, referring to FIG. 8, the user may select the firmware upgrade online information that he or she wants to upgrade in the interface displayed on the screen of the control terminal 10 to perform the firmware upgrade, or click on the one-key upgrade button to upgrade all the firmware online upgrade information that matches the scene roles currently in use.

It is to be noted that, for the version management of the firmware, since the embodiments of the present application realize the switching of multiple service forms based on a set of firmwares, there can be only one main line of development of a common firmware from the beginning to the end, so that the version management can be realized based on the main line of development, and, in addition, the scene role supported by the firmware upgrade information can be configured by the server.

Optionally, the method may further comprise steps 214-215 in order to realize the upgrade of the firmware of the removable platform:

Step 214: obtain role change firmware information; the role change firmware information includes one or more of: adding scene role information, deleting scene role information, and replacing scene role information.

Step 215: In response to an upgrade command to the role change firmware information, one or more of adding a scene role, deleting a scene role, and replacing a scene role is performed.

In an embodiment of the present application, the scene roles to be realized can be added into a scene role list, after which the scene role list is written into a persistent area in the storage space of the control terminal that can be accessed by the firmware, thereby realizing the establishment of the scene roles in the control terminal, which persistent area can be accessed by the firmware, thereby realizing the reading of the scene roles by the control terminal.

Further, if it is necessary to change the scene roles supported by the control terminal, it can be realized by means of firmware upgrading, i.e., obtaining the role change firmware information and changing the scene roles in the scene role list in accordance with the obtaining of the role change firmware information, with the change operations including, but not limited to, adding new scene roles, deleting scene roles, and replacing scene roles. Finally, you can write the changed scene role list into the persistence area to replace the original list, thus completing the upgrade. Since the whole upgrade process is based on firmware upgrade, it requires high management privileges, thus avoiding general users from tampering with the scene roles supported by the control terminal, and improving the stability and security of the scene role establishment process.

Optionally, the scene role is bound with a device model of the removable platform; the method may further comprise steps 216-217 in order to realize the upgrade of the firmware of the removable platform:

Step 216: Obtain device model change firmware information matching the currently used scene role, and the device model change firmware information includes one or more of: adding device model information, deleting device model information, and replacing device model information.

Step 217: In response to a command to upgrade the firmware information for a device model change, one or more of adding a device model, deleting a device model, and replacing a device model is performed.

In an embodiment of the present application, a service form may include one or more device models of the removable platform, and the device models may differentiate the device versions of the removable platform used in the service form, e.g., if the removable platform used in the agriculture-grade service form undergoes three device upgrades, the agriculture-grade service form may have a device model 1.0 of the removable platform, a device model 2.0 of the removable platform, and a device model 3.0 of the removable platform.

Since the scene roles are bound with the device models of the removable platforms, the device models bound with the scene roles can be written to a list of the device models bound with the list of scene roles, and the list of the device models can later be written to a persistent area in the storage space of the control terminal that can be accessed by the firmware, thus realizing the configuration of the device models bound by the scene roles, which persistent area can be accessed by the firmware, thereby realizing the configuration of the device models of the reading of the device models supported by the scene roles.

Further, if it is necessary to change the device models supported by the scene roles, it can be realized by means of firmware upgrading, i.e., obtaining the device model change firmware information that matches the scene roles currently used by the control terminal, and carrying out the change of the device models in the device model list in accordance with the device model change firmware information. The change operation include, but are not limited to, adding device model information, deleting device model information, and replacing device model information; finally, you can write the changed device model list into the persistence area to replace the original list, thus completing the upgrade. Since the whole upgrade process is based on firmware upgrade, it requires higher management privileges, which prevents general users from tampering with the device models supported by scene roles, and improves the stability and security of device model management.

Optionally, to enable upgrading of the firmware of the removable platform, the method may further comprise:

Step 218: After determining that the control terminal is wired connected to the server, the currently used scene role is sent to the server for the server to upgrade the firmware of the control terminal according to the firmware wired upgrade information matching the currently used scene role.

In one embodiment of the present application, a wired firmware upgrading method is provided, specifically for upgrading the firmware in the control terminal through the service terminal after wired connecting the control terminal to the service terminal. Wherein, the service terminal may be a device such as a personal computer, a server, etc., and the service terminal may have a networking function and a screen, and furthermore, the service terminal may not have a networking function, i.e., the service terminal may internally store firmware wired upgrade information.

Specifically, after determining that the control terminal is wired connected to the server terminal, the control terminal may send the currently used scene role to the server terminal, and after the server terminal obtains the currently used scene role, it may obtain the firmware wired upgrade information that matches with the currently used scene role by means of networking or local reading, and perform wired upgrade of the firmware of the control terminal according to the obtained firmware wired upgrade information. After the upgrade is completed, the control terminal can receive the upgrade completion notification sent by the server, as well as prompt the user that the wired upgrade is completed.

Optionally, to enable upgrading of the firmware of the removable platform, the method may further comprise:

Step 219: after determining that the control terminal is connected to the storage medium, obtaining the firmware offline upgrade information stored in the storage medium, and upgrading the firmware of the control terminal offline.

In one embodiment of the present application, an offline firmware upgrade method is provided, specifically, after wired connecting the control terminal to the storage medium, upgrading the firmware in the control terminal is carried out by means of the firmware offline upgrade information stored in the storage medium. Among them, the storage medium may be a hard disk, U disk, or other storage medium. After the upgrade is completed, the control terminal can prompt the user that the offline upgrade is completed.

Optionally, the method may further comprise:

Step 220: determine a range of positions in which the control terminal is located when the control terminal is activated.

Step 221: set the model of the navigation system utilized by the control terminal to a model of the navigation system that matches the range of the position in which the control terminal is located.

In an embodiment of the present application, there are four sets of commonly used navigation system models around the world, including: GLONASS navigation system models, Galileo navigation system models, GPS navigation system models, and BeiDou navigation system models, which usually have strong geographical characteristics due to the distribution location of satellites and servers. For example, Galileo and GLONASS are more effective in Europe and Central Asia, BeiDou is more effective in East Asia, and GPS is more effective in the Americas.

Therefore, based on the geographical characteristics of the navigation system model described above, the embodiments of the present application can determine the location range in which the control terminal is located at the time of activation of the control terminal, and set the navigation system model utilized by the control terminal to the navigation system model matching the location range in which the control terminal is located, e.g., if the control terminal is located in the East Asian region at the time of activation, at least a Beidou navigation system model can be selected as the model of the navigation system utilized by the control terminal.

Optionally, the navigation system model includes: a GLONASS navigation system model, a Galileo navigation system model, a GPS navigation system model, and a Beidou navigation system model; step 221 may specifically include:

Sub-step 2211: set a model of a navigation system utilized by the control terminal to a model of one or more navigation systems among the models of the navigation systems that match the range of the position in which the control terminal is located.

In the embodiment of the present application, the control terminal can realize navigation through multiple navigation systems at the same time so as to further improve the navigation accuracy, and therefore the model of the navigation system utilized by the control terminal can be set as one or more models of the navigation systems that match the range of the location where the control terminal is located, e.g., if the control terminal is in Europe at the time of startup, it can select the GLONASS model and the Galileo model for use at the same time.

In summary, the control device for a movable platform provided by embodiments of the present application can realize the management of a movable platform in different service forms by adopting role management on the same control terminal. Since scene roles are bound one by one to the service forms and the control terminal can only use one scene role to control the movable platform at one time, mutual interference in controlling movable platforms in different service forms can be avoided, and the control terminal can only use one scene role to control the movable platform at one time. Therefore, the embodiment of the present application realizes the management of the movable platform under different service forms by using the same control terminal through the concept of scene roles, for example, when it is necessary to switch the service form, it can be realized by switching scene roles on one control terminal, which improves the control and management efficiency of the movable platform under different service forms.

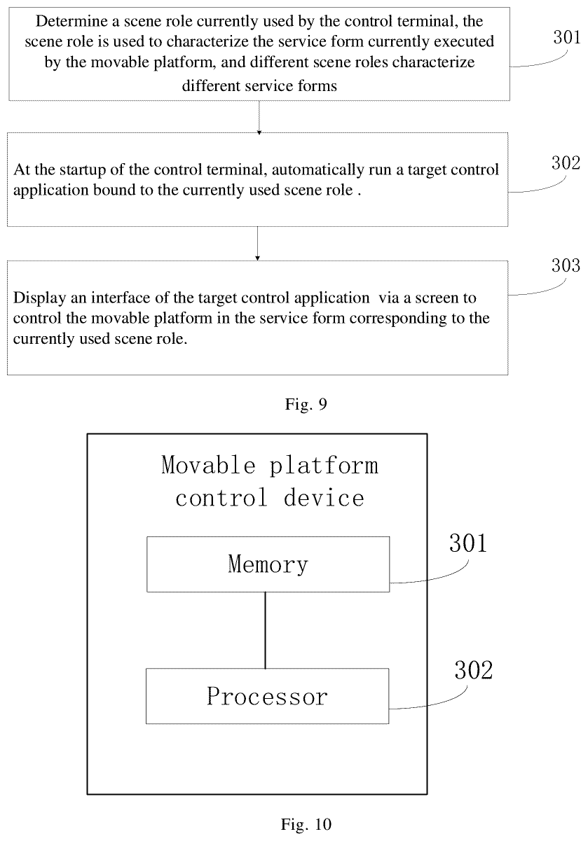

FIG. 9 is a specific flowchart of a method of controlling a movable platform provided by an embodiment of the present application, which may include, as shown in FIG. 9:

Step 301: determine a scene role currently used by the control terminal, the scene role is used to characterize a service form currently executed by the movable platform, and different scene roles characterize different service forms.

This step can be specified with reference to 101 above and will not be repeated here.

Step 302: at the startup of the control terminal, a target control application bound to the currently used scene role is automatically run.

Optionally, the scene role is bound to a corresponding control application.

In an embodiment of the present application, in order to improve the efficiency of the control terminal and reduce the length of the preparation time required before the control terminal starts, a target control application that is bound to the currently used scene role can be automatically run when the control terminal is started.

For example, if the user has set the power-on default scene role as an agricultural level scene role, the control terminal can automatically start the agricultural level control application bound to the agricultural level scene role when the control terminal is started, or the control terminal automatically starts the agricultural level control application bound to the agricultural level scene role when the control terminal is powered on and the user selects the agricultural level scene role, so as to enhance the control efficiency.

Step 303: an interface of the target control application is displayed via a screen to control the movable platform in the service form corresponding to the currently used scene role.

In the embodiment of the present application, after the control terminal automatically runs the target control application bound to the currently used scene role, it can carry out control of the movable platform in the service form corresponding to the currently used scene role by means of displaying an interface of the target control application on the screen.

Optionally, step 303 may specifically include:

Substep 3031: at the startup of the control terminal, if no customized control application is set, the target control application bound to the currently used scene role is automatically run.

Substep 3032: If a customized control application is set at the startup of the control terminal, the customized control application is run automatically in priority.

In the embodiments of the present application, when controlling the movable platform, the user usually has diversified personalized needs, and based on such needs, the user can define the application that automatically runs when the control terminal is started, for example, in a scene where the user needs to locate the current position through the mapping software before controlling the movable platform, the user can set the customized control application to be the mapping application, so that the map application will be automatically run as a priority to locate the current position when the control terminal is started, thereby satisfying the user's personalized needs. If the customized control application is not set when the control terminal starts up, the target control application bound to the currently used scene role can be automatically run.

In summary, the method of controlling a movable platform provided by embodiments of the present application can realize the management of movable platforms under different service forms by adopting role management on the same control terminal. Since scene roles are bound one by one to the service forms and the control terminal can only use one scene role to control the movable platform at one time, mutual interference in controlling movable platforms under different service forms can be avoided, and the control terminal can only use one scene role to control the movable platform at one time. Therefore, the embodiment of the present application realizes the management of the movable platform under different service forms by using the same control terminal through the concept of scene roles, for example, when it is necessary to switch the service form, it can be realized by switching scene roles on one control terminal, which improves the control and management efficiency of the movable platform under different service forms.

FIG. 10 is a structural diagram of a control terminal of a movable platform provided by an embodiment of the present application, as shown in FIG. 10, which may include:
at least one processor 402; and
at least one memory 401 including computer program code, where the at least one memory and the computer program code are configured, with the at least one processor 402, to cause the control apparatus to at least:
determine a scene role currently used by said control terminal, said scene role being used to characterize a service form currently executed by said movable platform, with different service forms characterized by different said scene roles; and control the movable platform to execute an operation in a service form corresponding to the scene role currently used.

Optionally, the scene role has a corresponding binding control application;
The processor is specifically configured to:
show the target control application bound to the currently used scene role through the screen and hides the control applications bound to scene roles other than the currently used scene role.

Optionally, the processor is also configured to:
In response to a triggered operation on the target control application, the target control application is run and the movable platform in the service form corresponding to the currently used scene role is controlled.

Optionally, the scene role has a corresponding binding control application;
The processor is specifically configured to:
automatically run the target control application bound to the currently used scene role when the control terminal is started; and
display the interface of the target control application through the screen.

Optionally, the processor is specifically configured to:
if no custom control application is set when the control terminal starts, the target control application bound to the currently used scene role is automatically run.

Optionally, the processor is also configured to:
if a customized control application is set when the control terminal starts up, the customized control application is run automatically as a priority.

Optionally, the processor is specifically configured to:
determines the scene role that is set by default when the control terminal starts up to the currently used scene role.

Optionally, the processor is specifically configured to:
prompt the user to make a selection of a scene role by the information output device, and in response to the role selection operation of the user, the selected scene role is determined to be the currently used scene role.

Optionally, the processor is specifically configured to:
display a role selection interface that includes multiple scene roles through the screen;
In response to a selection operation on a scene actor in the actor selection screen, the selected scene actor is identified as the currently used scene actor.

Optionally, the processor is specifically configured to:
determines the scene role used by the control terminal before the last shutdown as the currently used scene role.

Optionally, the processor is specifically configured to:
obtain a target service form to which the movable platform belongs as the movable platform is communicatively connected to the control terminal;
identify the scene role corresponding to the target service form as the currently used scene role.

Optionally, the processor is also configured to:
in response to the role switching command, switch the scene role currently used by the control terminal from the first scene role to the second scene role.

Optionally, the processor is specifically configured to:
display a role switching interface that includes multiple scene roles through the screen;
In response to a switching operation of a scene role in the role switching interface, the scene role currently used by the control terminal is switched from a first scene role to a second scene role.

Optionally, the processor is also configured to:
after determining that the control terminal disconnects the communication connection with the first movable platform and establishes a new communication connection with the second movable platform, acquire the second service form to which the second movable platform belongs;
switching the scene role currently used by the control terminal from a first scene role corresponding to a first service form to which the first movable platform belongs to a second scene role corresponding to a second service form.

Optionally, the processor is also configured to:
in the case where it is determined that the control terminal has a communication connection with the removable platform, prohibit switching the scene role currently used by the control terminal.

Optionally, the processor is specifically configured to:
if it is determined that the user is switching the scene role currently used by the control terminal when the removable platform to which the control terminal is currently connected is in a working state, prompt the user to prohibit switching the scene role currently used by the control terminal.

Optionally, the processor is also configured to:
In switching the scene role currently used by the control terminal from the first scene role to the second scene role, switch the movable platform control method of the control terminal from the first method corresponding to the first scene role to the second method corresponding to the second scene role.

Optionally, the processor is specifically configured to:
switch a function controlled by an operation structure of a control terminal from a first function corresponding to a first scene role to a second function corresponding to a second scene role.

Optionally, the firmware of the control terminal comprises: software radio firmware tied to the scene roles;
The processor is also configured to:
in switching the scene role currently used by the control terminal from the first scene role to the second scene role, switch the software radio firmware of the control terminal from the first software radio firmware corresponding to the first scene role to the second software radio firmware corresponding to the second scene role.

Optionally, the processor is further configured to: obtain firmware online upgrade information matching the currently used scene role;
The processor is also configured to: hide firmware online upgrade information that does not match the currently used scene role.

Optionally, the processor is also configured to:
display firmware online upgrade information through the screen; and
in response to an upgrade command to the firmware upgrade online message, upgrade the firmware of the control terminal online.

Optionally, the firmware online upgrade information includes the supported scene roles and the device models of the supported removable platforms.

Optionally, the processor is also configured to:
obtain role change firmware information; the role change firmware information includes one or more of: adding scene role information, deleting scene role information, and replacing scene role information.

Optionally, the processor is also configured to:
performs one or more of adding a scene role, deleting a scene role, or replacing a scene role in response to an upgrade command to the role change firmware information.

Optionally, the scene role is bound to a device model of a removable platform;
The processor is also configured to:
obtain device model change firmware information that matches the currently used scene role, and the device model change firmware information includes one or more of: adding device model information, deleting device model information, and replacing device model information.

Optionally, the processor is also configured to:
perform one or more of adding a new device model, deleting a device model, or replacing a device model in response to an upgrade command that changes firmware information for a device model.

Optionally, the processor is also configured to:
after determining that the control terminal is wired connected to the server, send the currently used scene role to the server for the server to upgrade the firmware of the control terminal according to the firmware wired upgrade information matching the currently used scene role.

Optionally, the processor is also configured to:
after determining that the control terminal is connected to the storage medium, obtain the firmware offline upgrade information stored in the storage medium, and upgrade the firmware of the control terminal offline.

Optionally, the processor is also configured to:
determine the range of positions in which the control terminal is located when the control terminal is activated; and
set the model of the navigation system utilized by the control terminal to the model of the navigation system that matches the range of the position in which the control terminal is located.

Optionally, the navigation system model includes: a GLONASS navigation system model, a Galileo navigation system model, a GPS navigation system model, and a BeiDou navigation system model;
The processor is specifically configured to:
set the model of the navigation system utilized by the control terminal to one or more models of navigation systems among the models of the navigation systems that match the range of the position in which the control terminal is located.

Optionally, the service form includes one or more of: an industry-level service form, an agricultural-level service form, a performance-level service form, and a consumer-level service form.

In summary, the control device for a movable platform provided by embodiments of the present application can realize the management of a movable platform in different service forms by adopting role management on the same control terminal. Since scene roles are bound one by one to the service forms and the control terminal can only use one scene role to control the movable platform at one time, mutual interference in controlling movable platforms in different service forms can be avoided, and the control terminal can only use one scene role to control the movable platform at one time. Therefore, the embodiment of the present application realizes the management of the movable platform under different service forms by using the same control terminal through the concept of scene roles, for example, when it is necessary to switch the service form, it can be realized by switching scene roles on one control terminal, which improves the control and management efficiency of the movable platform under different service forms.

Optionally, referring to FIG. 1, embodiments of the present application also provide a control system for a movable platform, the system comprising: a control terminal 10 and a movable platform 20; a control device for the movable platform included in the control terminal 10.

Optionally, the movable platform comprises at least one of an unmanned aircraft, an unmanned vehicle, and an unmanned boat.

Embodiments of the present application also provide a computer-readable storage medium, the computer-readable storage medium having a computer program stored thereon, the computer program being executed by a processor to realize the various processes of the above embodiments of the method for controlling the removable platform, and being able to achieve the same technical effect, which is not repeated herein to avoid repetition. Wherein, the computer-readable storage medium, such as a Read-Only Memory (Read-Only Memory, abbreviated as ROM), a Random Access Memory (Random Access Memory, abbreviated as RAM), a disk or a CD-ROM.

Embodiments of the present application also provide a computer program product, the computer program product comprising a computer program, the steps of a method of controlling a removable platform implemented when the computer program is executed by a processor.

The memory may be an interface for an external control terminal to connect to a control device of the removable platform. For example, the external control terminal may include a wired or wireless headset port, an external power (or battery charger) port, a wired or wireless data port, a memory card port, a port for connecting to a control terminal having an identification module, an audio input/output (I/O) port, a video I/O port, a headset port, and the like. The memory may be used to receive input from an external control terminal (e.g., data information, power, etc.) and transmit the received input to one or more components within the control device of the removable platform or may be used to transmit data between the control device of the removable platform and the external control terminal.

Examples include at least one disk memory device, flash memory device, or other volatile solid state memory device.

The processor is a control center of the control terminal, connecting various parts of the entire control terminal using various interfaces and lines, performing various functions of the control terminal and processing data by running or executing software programs and/or modules stored in the memory, and calling data stored in the memory, so as to monitor the control terminal as a whole. The processor may comprise one or more processing units; preferably, the processor may integrate an application processor and a modem processor, wherein the application processor mainly handles the operating system, the user interface and the application programs, etc., and the modem processor mainly handles wireless communication. It will be appreciated that the modem processor described above may also not be integrated into the processor.

The various embodiments in this specification are described in a progressive manner, each embodiment focuses on the differences with other embodiments, and the same and similar parts between the various embodiments can be referred to each other.

It should be appreciated by those skilled in the art that embodiments of the present application may be provided as methods, control terminals, or computer program products. Thus, the present application may take the form of a fully hardware embodiment, a fully software embodiment, or an embodiment that combines software and hardware aspects. Further, the present application may take the form of a computer program product implemented on one or more computer-usable storage media (including, but not limited to, disk memory, CD-ROM, optical memory, and the like) that contain computer-usable program code therein.

The present application is described with reference to flowcharts and/or block diagrams of methods, terminal devices (systems), and computer program products according to the present application. It is to be understood that each of the processes and/or boxes in the flowchart and/or block diagram, and combinations of the processes and/or boxes in the flowchart and/or block diagram, may be implemented by computer program instructions. These computer program instructions may be provided to a processor of a general-purpose computer, a special-purpose computer, an embedded processor, or other programmable data-processing terminal device to produce a machine such that the instructions executed by the processor of the computer or other programmable data-processing terminal device produce a control for carrying out the functions specified in the process or processes of the flowchart and/or the box or boxes of the block diagram terminal.

These computer program instructions may also be stored in a computer-readable memory capable of directing a computer or other programmable data processing terminal device to operate in a particular manner, such that the instructions stored in that computer-readable memory produce an article of manufacture comprising an instruction-controlled terminal that implements the functions specified in the flowchart one process or more processes and/or the block diagram one box or more boxes.

These computer program instructions may also be loaded onto a computer or other programmable data processing terminal device such that a series of operational steps are executed on the computer or other programmable terminal device to produce computer-implemented processing, such that the instructions executed on the computer or other programmable terminal device provide instructions for implementing the functions specified in the one process or multiple processes of the flowchart and/or the one or more boxes of the block diagram or steps for realizing the functions specified in the one or more processes of the flowchart and/or the one or more boxes of the block diagram.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Although preferred embodiments of the present application have been described, those skilled in the art may make additional changes and modifications to these embodiments once the basic inventive concepts are known. Therefore, the appended claims are intended to be construed to include the preferred embodiments as well as all changes and modifications that fall within the scope of this application.

Finally, it should also be noted that, in this document, relational terms such as first and second are used only to distinguish one entity or operation from another, and do not necessarily require or imply the existence of any such actual relationship or order between those entities or operations. Furthermore, the terms “including”, “comprising”, or any other variant thereof, are intended to cover non-exclusive inclusion such that a process, method, article, or end device comprising a set of elements includes not only those elements, but also other elements not explicitly listed, or other elements that are not explicitly listed for the purpose of the process, method, article, or end device. other elements, or also elements that are inherent to such process, method, article, or end device. Without further limitation, the fact that an element is qualified by the statement “includes a . . . ” does not exclude the existence of another identical element in the process, method, article or end device that includes the element.

This application is described in detail above, and specific examples are applied herein to illustrate the principles and implementations of this application, and the illustrations of the above examples are only used to help understand the method of this application and its core ideas; at the same time, for the general technical personnel in the field, based on the ideas of this application, there will be changes in the specific implementations and the scope of the application, and, in summary, the contents of this specification should not be construed as a limitation of this application. In summary, the contents of this specification should not be construed as a limitation of the present application.

What is claimed is:

1. A method of controlling a movable platform, comprising:
determining a current scene role currently used by a control terminal to control a first movable platform as a first scene role, the first scene role corresponding to a first service form currently executed by the first movable platform;
automatically selecting a corresponding control function based on the current scene role;
after determining that the control terminal has disconnected communication connection with the first movable platform and established a new communication connection with a second movable platform, obtaining a second service form to which the second movable platform belongs; and
switching the current scene role currently used by the control terminal from the first scene role corresponding to the first service form to which the first movable platform belongs to a second scene role corresponding to the second service form to which the second movable platform belongs.

2. The method according to claim 1, wherein the automatically selecting the corresponding control function based on the current scene role comprises:
displaying a target control application bound to the current scene role on a screen, and
hiding control applications bound to scene roles other than the current scene role on the screen.

3. The method according to claim 2, further comprising:
in response to a triggering operation on the target control application, running the target control application and controlling the first movable platform to execute the first service form corresponding to the current scene role.

4. The method according to claim 1, wherein the automatically selecting the corresponding control function based on the current scene role comprises:
automatically running a target control application bound to the current scene role upon startup of the control terminal; and
displaying an interface of the target control application on a screen.

5. The method according to claim 4, wherein the automatically running the target control application bound to the current scene role upon startup of the control terminal further comprises:
determining that no customized control application is set upon startup of the control terminal before the automatically running the target control application.

6. The method according to claim 1, wherein the automatically selecting the corresponding control function based on the current scene role comprises:
determining that a customized control application was set upon startup of the control terminal; and
automatically running the customized control application at the startup of the control terminal.

7. The method according to claim 1, wherein the determining the current scene role currently used by the control terminal comprises:
determining a scene role set by default at startup of the control terminal to be the current scene role.

8. The method according to claim 1, wherein the determining the current scene role currently used by the control terminal comprises:
prompting the user to make a selection of a scene role on an information output device, and
determining the selected scene role to be the current scene role in response to role selection operation of the user.

9. The method according to claim 8, wherein the prompting the user to make the selection of the scene role on the information output device and determining the selected scene role to be the current scene role in response to the role selection operation of the user comprises:
displaying a role selection interface that includes a plurality of scene roles on a screen of the information output device;
performing the role selection operation by the user at the role selection interface to select the scene role among the plurality of scene roles; and
determining the selected scene role among the plurality of scene roles to be the current scene role in response to the role selection operation of the user at the role selection interface.

10. The method according to claim 1, wherein the determining the current scene role currently used by the control terminal comprises:
determining a scene role used by the control terminal prior to its last shutdown as the current scene role, or
obtaining a target service form to which the first movable platform belongs, the first movable platform being communicatively connected to the control terminal; and
identifying a scene role corresponding to the target service form as the current scene role.

11. The method according to claim 1, further comprising:
displaying a role switching interface including a plurality of scene roles; and
in response to a switching operation of the scene roles in the role switching interface, switching the current scene role currently used by the control terminal to one of the plurality of scene roles.

12. The method according to claim 1, further comprising:
prohibiting switching of the current scene role currently used by the control terminal in a case that the control terminal maintains a communication connection with the first removable platform.

13. The method according to claim 12, wherein the prohibiting switching of the current scene role currently used by the control terminal in the case that the control terminal maintains the communication connection with the first removable platform comprises:
in a case where the first movable platform to which the control terminal is currently connected is in a working state, and it is determined that the user is switching the current scene role currently used by the control terminal, prompting the user to prohibit switching the current scene role currently used by the control terminal.

14. The method according to claim 1, further comprising:
in switching the current scene role currently used by the control terminal from the first scene role to the second scene role, switching a movable platform control mode of the control terminal from a first mode corresponding to the first scene role to a second mode corresponding to the second scene role.

15. The method according to claim 14, wherein the switching the removable platform control mode of the control terminal from the first mode corresponding to the first scene role to the second mode corresponding to the second scene role comprises:
switching a function controlled by an operative structure of the control terminal from a first function corresponding to the first scene role to a second function corresponding to the second scene role.

16. The method according to claim 1, further comprising:
in switching the current scene role currently used by the control terminal from the first scene role to the second scene role, switching a software radio firmware of the control terminal from a first software radio firmware corresponding to the first scene role to a second software radio firmware corresponding to the second scene role; or
obtaining device model change firmware information that matches the current scene role, the device model change firmware information including: one or more of adding device model information, deleting device model information, or replacing device model information;
in response to an upgrade instruction for the device model change firmware information, executing one or more of adding a device model, deleting a device model, or replacing a device model.

17. The method according to claim 1, wherein, after the determining the current scene role currently used by the control terminal, the method further comprising:
after determining that the control terminal is communicatively connected to a server, sending the current scene role to the server for the server to upgrade a firmware of the control terminal based on firmware upgrade information matching the current scene role.

18. The method according to claim 1, wherein the service form comprises one or more of: an industry level service form, an agricultural level service form, a performance level service form, or a consumer level service form.

19. A control apparatus for a moveable platform, comprising:
at least one processor; and
at least one memory including computer program code, where the at least one memory and the computer program code are configured, with the at least one processor, to cause the control apparatus to at least:
determine a current scene role currently used by a control terminal to control a first movable platform as a first scene role, the first scene role corresponding to a first service form currently executed by the first movable platform;
automatically select a corresponding control function based on the current scene role;
after determining that the control terminal has disconnected communication connection with the first movable platform and established a new communication connection with a second movable platform, obtain a second service form to which the second movable platform belongs; and
switch the current scene role currently used by the control terminal from the first scene role corresponding to the first service form to which the first movable platform belongs to a second scene role corresponding to the second service form to which the second movable platform belongs.

20. A control system for a movable platform, the control system comprising:
a control apparatus;
a first removable platform and a second removable platform;
the control apparatus comprises:
at least one processor; and
at least one memory including computer program code, where the at least one memory and the computer program code are configured, with the at least one processor, to cause the control apparatus to at least:
determine a current scene role currently used by a control terminal to control a first movable platform as a first scene role, the first scene role corresponding to a first service form currently executed by the first movable platform;
automatically select a corresponding control function based on the current scene role;
after determining that the control terminal has disconnected communication connection with the first movable platform and established a new communication connection with a second movable platform, obtain a second service form to which the second movable platform belongs; and
switch the current scene role currently used by the control terminal from the first scene role corresponding to the first service form to which the first movable platform belongs to a second scene role corresponding to the second service form to which the second movable platform belongs.
